(19) United States
(12) Patent Application Publication
(10) Pub. No.: US 2024/0227767 A1
(43) Pub. Date: Jul. 11, 2024

(54) PREDICTION DEVICE AND PREDICTION METHOD FOR AT LEAST ONE BRAKE SYSTEM COMPONENT OF A BRAKE SYSTEM OF A VEHICLE

(71) Applicant: Robert Bosch GmbH, Stuttgart (DE)

(72) Inventor: Michael Zeutzius, Tamm (DE)

(21) Appl. No.: 18/558,103

(22) PCT Filed: May 12, 2022
(86) PCT No.: PCT/EP2022/062948

§ 371 Date: Oct. 30, 2023

(30) Foreign Application Priority Data
May 19, 2021 (DE) 10 2021 205 091.3

(51) Int. Cl. B60T 17/22

(52) U.S. Cl. CPC B60T 17/221; B60T 2270/406; B60T 2270/413

(57) ABSTRACT

A prediction device and method for a brake system component of a brake system of a vehicle. The method includes: ascertaining value groups, which respectively have values ascertained during several braking processes of the vehicle, each comprising a braking request specification variable ascertained at a point in time, at least one brake system response variable ascertained at the same point in time, and a vehicle response variable ascertained at the same point in time; entering the ascertained value groups into coordinate systems which each has at least two axes, which respectively indicate the braking request specification variable or a braking request specification variable, the brake system response variable or at least one of the brake system response variables, and/or the vehicle response variable or a vehicle response variable; and estimating based on the coordinate systems whether an occurrence of a functional impairment of the brake system component is probable.

### FIELD

The present invention relates to a prediction device for at least one brake system component of a brake system of a vehicle. Likewise, the present invention relates to a prediction method for at least one brake system component of a brake system of a vehicle.

### BACKGROUND INFORMATION

Methods for monitoring a motor vehicle are described in the related art. For example, German Patent Application No. DE 10 2017 218 446 A1 describes a method for monitoring a motor vehicle with an automated driving function, in which method an energy store, which supplies at least one consumer designed to bring the motor vehicle to its standstill, is in particular monitored.

### SUMMARY

The present invention provides a prediction device for at least one brake system component of a brake system of a vehicle, and a prediction method for at least one brake system component of a brake system of a vehicle.

The present invention creates advantageous possibilities not only for monitoring but also for early diagnosis of at least one brake system component of a brake system of a vehicle. In particular, an early diagnosis for the entire brake system can be created by means of the present invention. The present invention thus enables not only a recognition of an already occurred failure of at least the one brake system component of the respective brake system but also a prediction with respect to a future functionality and a future operating behavior of at least the one brake system component of the brake system. As explained in more detail below, the future functionality for a multitude of different brake system components, e.g., for an electromechanical brake power booster upstream of a master brake cylinder of the respective brake system, and/or for a motorized plunger device (such as specifically an integrated power brake (IPS)) integrated in the respective brake system, can be reliably predicted by means of the present invention. Since a future functional impairment or a future failure of at least the one brake system component of the respective brake system can be predicted earlier by using the present invention, the present invention is also advantageously suitable for securing an autonomous driving of the vehicle equipped with the respective brake system.

In an advantageous embodiment of the prediction device of the present invention, the electronic device is designed and/or programmed to store the coordinate systems with the entered value groups in a memory device of the prediction device, wherein the electronic device is additionally designed and/or programmed to compare value groups ascertained during further driver-induced and/or autonomous braking processes of the vehicle to the coordinate systems stored in the memory device, in order to ascertain on the basis of the comparison whether a braking maneuver of the braking process currently being performed by the vehicle deviates from comparative braking maneuvers of the braking processes performed during the ascertainment of the value groups of the coordinate systems, and to estimate, additionally taking into account an ascertained frequency of the braking maneuvers of the braking processes that are currently being performed by the vehicle and deviate from the comparative braking maneuvers, whether an occurrence of at least one functional impairment of at least the one brake system component of the brake system is probable at least during the specified prediction time interval. By examining the entire “cascade” by means of the present invention, it can be reliably recognized at which brake system component or which brake system components of the respective brake system a functional impairment, fault or failure occurs. As explained in more detail below, the prediction performed for at least the one brake system component of the vehicle by means of the embodiment of the prediction device described here is further improved. In particular, a probable maximum travel range can be estimated by means of the embodiment of the prediction device described here.

For example, the prediction device may be mountable on the vehicle. The vehicle can thus be/become equipped with its own prediction device.

Alternatively, according to an example embodiment of the present invention, the prediction device may comprise a communication device designed to receive the value groups transmitted by a data transmitting device of the vehicle. In this case, mounting the prediction device on the vehicle is not necessary. The embodiment of the prediction device of the present invention described here can therefore be designed without any problem with a comparatively large volume and/or a relatively high weight. In addition, the embodiment of the prediction device of the present invention described here can also be used by several vehicles which receive value groups transmitted by their data transmitting devices, and can therefore be used for monitoring and for early diagnosis of at least the one brake system component of the brake systems of the vehicles.

The advantages described above are also ensured when a corresponding prediction method for at least one brake system component of a brake system of a vehicle is performed.

In an advantageous embodiment of the prediction method of the present invention, a rod path of an input rod connected to the brake pedal, an adjustment velocity of the input rod, a target motor current intensity of a motor of a motorized brake pressure build-up device of the brake system requested by the automatic braking or driving control system, a target operating voltage of the motor of the motorized brake pressure build-up device requested by the automatic braking or driving control system, a target motor torque of the motor of the motorized brake pressure build-up device requested by the automatic braking or driving control system, a target power consumption of the motor of the motorized brake pressure build-up device requested by the automatic braking or driving control system, a target adjustment path of at least one adjustable piston of the motorized brake pressure build-up device requested by the automatic braking or driving control system, and/or a target pump rate of at least one pump used in the brake system, said pump rate being requested by the automatic braking or driving control system, are ascertained as the at least one braking request specification variable. The examples listed here for the at least one braking request specification variable can be measured by means of sensor systems traditionally already used in each vehicle type or can be reliably read from at least one signal of the automatic braking or driving control system.

Alternatively, or additionally, according to an example embodiment of the present invention, a master brake cylinder pressure in a master brake cylinder of the brake system, at least one brake pressure in at least one wheel brake cylinder of the brake system, a motor current intensity of the motor of the motorized brake pressure build-up device of the brake system, an operating voltage of the motor of the motorized brake pressure build-up device, a motor torque of the motor of the motorized brake pressure build-up device, a power consumption of the motor of the motorized brake pressure build-up device, an adjustment path of the at least one adjustable piston of the motorized brake pressure build-up device, controller state information about any performed brake pressure control or any performed driving dynamics control, at least one temperature on and/or in at least the motorized brake pressure build-up device, a pump rate of the at least one pump used in the brake system, a gearbox efficiency of a gearbox of the brake system connected to the motorized brake pressure build-up device, and/or at least one switching state of at least one valve of the brake system can be ascertained as the at least one brake system response variable. The embodiment of the prediction method according to the present invention described here can thus be performed without any extension of the sensor system traditionally already installed on the vehicle.

Likewise, according to an example embodiment of the present invention, a brake power produced on the vehicle by means of the brake system, a braking torque produced on the vehicle by means of the brake system, a steering angle of the vehicle, a yaw rate of the vehicle, a vehicle deceleration produced on the vehicle by means of the brake system, a longitudinal velocity of the vehicle, a lateral velocity of the vehicle, a lateral acceleration of the vehicle, and/or an on-board power supply voltage of an on-board power supply of the vehicle can be ascertained as the at least one vehicle response variable. The examples listed here for the at least one vehicle response variable can also generally be determined without any extension of the sensor system traditionally already installed on the vehicle.

In an advantageous development of the prediction method of the present invention, in addition to the at least one braking request specification variable ascertained at the respective point in time of the associated value group, the at least one brake system response variable ascertained at the same point in time, and the at least one vehicle response variable of the respective value group ascertained at the same point in time, at least one environmental parameter with respect to a current environment of the vehicle is ascertained at the same point in time and added to the respective value group, wherein the value groups are entered into at least one further coordinate system in which the environmental parameter or at least one of the environmental parameters is indicated by means of an axis of the respective further coordinate system or by means of sectors in a plane spanned by two axes of the respective further coordinate system, and wherein, additionally taking into account the at least one further coordinate system, it is estimated whether an occurrence of at least one functional impairment of at least the one brake system component of the brake system is probable at least during the specified prediction time interval. Environmental conditions can thus additionally also be taken into account in the prediction produced by means of the embodiment of the prediction method of the present invention described here.

For example, a roadway friction, a roadway inclination angle, a windshield wiper status, and/or an outside temperature can be ascertained as the at least one environmental parameter. Since the braking behavior of the vehicle is frequently impaired by such environmental conditions, also taking into account at least one of the environmental parameters listed here can improve the prediction.

Furthermore, the coordinate systems with the entered value groups can be stored in a memory device, wherein value groups ascertained during further driver-induced and/or autonomous braking processes of the vehicle are compared to the coordinate systems stored in the memory device, in order to ascertain on the basis of the comparison whether a braking maneuver of the braking process currently being performed by the vehicle deviates from comparative braking maneuvers of the braking processes performed during the ascertainment of the value groups of the coordinate systems, and wherein, additionally taking into account an ascertained frequency of the braking maneuvers of the braking processes that are currently being performed by the vehicle and deviate from the comparative braking maneuvers, it is estimated whether an occurrence of at least one functional impairment of at least the one brake system component of the brake system is probable at least during the specified prediction time interval. The advantages of the embodiment of the prediction method according to the present invention described here are explained in detail below.

### BRIEF DESCRIPTION OF THE DRAWINGS

Further features and advantages of the present invention are explained below with reference to the figures.

FIGS. 1A to 1G show a flowchart and coordinate systems for explaining a first example embodiment of the prediction method of the present invention.

FIG. 2 shows a flowchart for explaining a second embodiment of the prediction method, according to the present invention.

FIG. 3 shows a flowchart for explaining a third embodiment of the prediction method according to the present invention.

FIG. 4 shows a schematic representation of an example embodiment of the prediction device according to the present invention.

### DETAILED DESCRIPTION OF EXAMPLE EMBODIMENTS

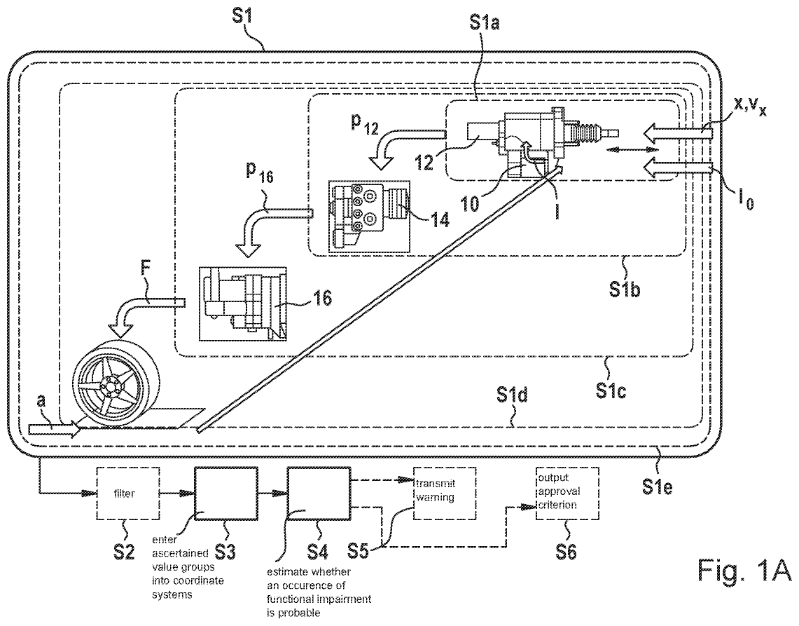

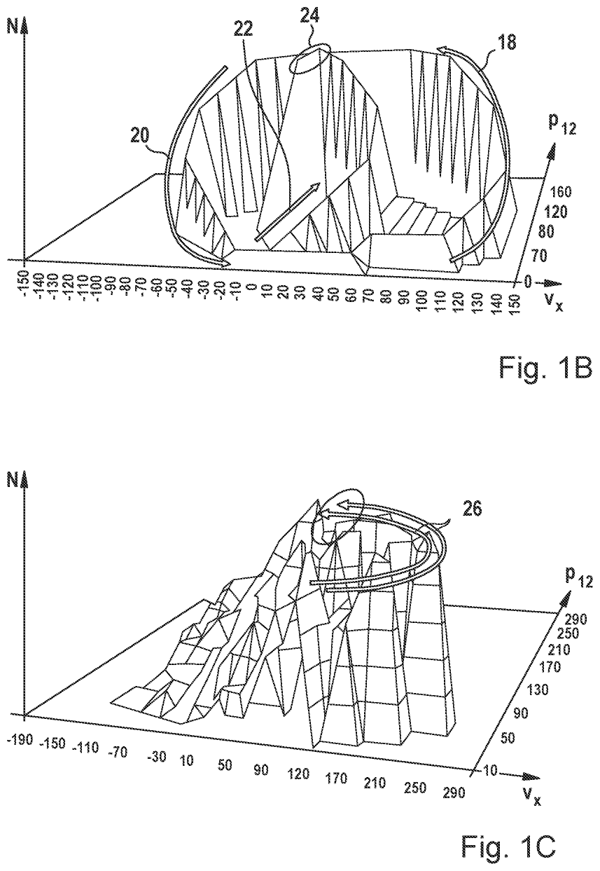

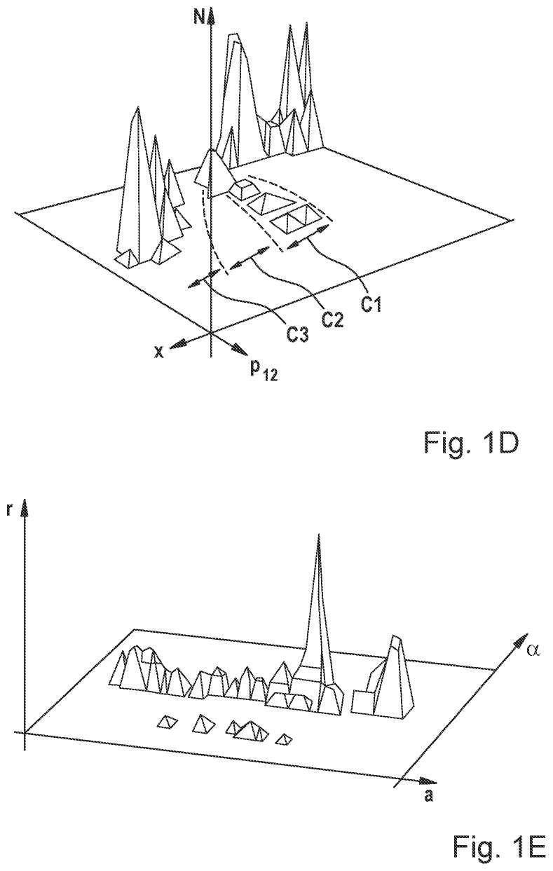

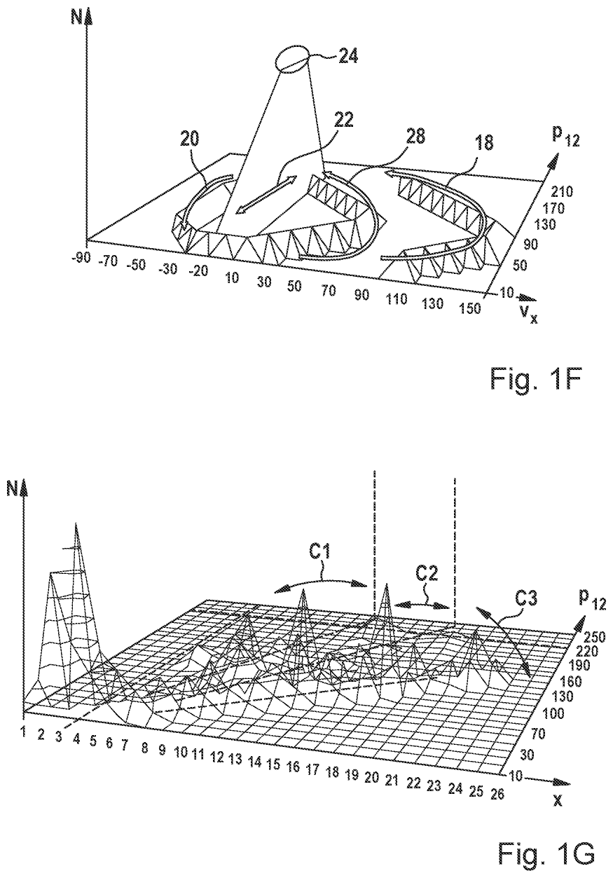

FIGS. 1A to 1G show a flowchart and coordinate systems for explaining a first embodiment of the prediction method.

The prediction method described below can be performed for a multitude of different types of brake systems. The prediction method described below can be performed even for a brake-by-wire brake system. It is expressly pointed out that a feasibility of the prediction method is also not restricted to a specific vehicle type/motor vehicle type of the vehicle/motor vehicle equipped with the respective brake system.

In a method step S1 of the prediction method, value groups of values are ascertained during several driver-induced and/or autonomous braking processes of the vehicle. Each of the value groups (fully) ascertained in method step S1 respectively comprises at least one braking request specification variable x, vₓ and I₀ ascertained at a point in time, at least one brake system response variable p₁₂, I and p₁₆ ascertained at the same point in time, and at least one vehicle response variable F, α, r and a ascertained at the same point in time.

In the embodiment of FIGS. 1A to 1G, method step S1 is divided into sub-steps S1a to S1e. In sub-step S1a, the at least one braking request specification variable x, vₓ and I₀ is determined at the respective point in time of the associated value group. The at least one braking request specification variable x, vₓ and I₀ is respectively to be understood as a variable which reflects an actuation of a brake pedal by a driver of the vehicle and/or a braking request specification of an automatic braking or driving control system of the vehicle. The automatic braking or driving control system can, for example, comprise a driver assistance system, such as specifically an adaptive cruise control (ACC) system, an emergency brake system and/or an automatic system used to autonomously drive the vehicle. The braking request specification of the automatic braking or driving control system can be at least one signal by means of which the automatic braking or driving control system controls autonomous braking or autonomous driving of the vehicle.

By way of example, in sub-step S1a, a rod path x of an input rod connected to the brake pedal and an adjustment velocity vₓ of the input rod are ascertained as the at least one braking request specification variable x, vₓ and I₀, which reflects the actuation of the brake pedal by the driver. Additionally ascertained is a target motor current intensity I₀ of a motor of an electromechanical brake power booster 10 which is used as the motorized brake pressure build-up device of the brake system and is upstream of a master brake cylinder 12 of the brake system, said target motor current intensity being requested by the automatic braking or driving control system. The target motor current intensity I₀ of the motor of the electromechanical brake power booster 10 can, for example, be read out from the braking request specification of the automatic braking or driving control system.

It is also pointed out here that the target motor current intensity I₀ is to be interpreted only as an example for a braking request specification variable x, vₓ and I₀ which reflects the braking request specification of the automatic braking or driving control system. A target operating voltage of the motor of the motorized brake pressure build-up device requested by the automatic braking or driving control system, a target motor torque of the motor of the motorized brake pressure build-up device requested by the automatic braking or driving control system, a target power consumption of the motor of the motorized brake pressure build-up device requested by the automatic braking or driving control system, a target adjustment path of at least one adjustable piston of the motorized brake pressure build-up device requested by the automatic braking or driving control system, and/or a target pump rate of at least one pump 14 used in the brake system, said pump rate being requested by the automatic braking or driving control system, can also be ascertained as the at least one braking request specification variable x, vₓ and I₀ instead of, or in addition to, the target motor current intensity I₀. The use of the electromechanical brake power booster 10 as a motorized brake pressure build-up device is also to be interpreted only as an example. Alternatively, or additionally, an integrated plunger device (such as specifically an integrated power brake (IPB)) can also be (co-) used as a motorized brake pressure build-up device.

In sub-steps S1b and S1c, at the respective point in time of the associated value group, the at least one brake system response variable p₁₂, I and p₁₆, which respectively reflects a response of at least one brake system component of the brake system to the at least one braking request specification variable x, vₓ and I₀ or to a state on and/or in at least the one brake system component, is ascertained. By way of example, in sub-step S1b, a master brake cylinder pressure p₁₂ in the master brake cylinder 12 of the brake system and a motor current intensity I of the motor of the electromechanical brake power booster 10 used as the motorized brake pressure build-up device are determined as the at least one brake system response variable p₁₂, I and p₁₆. An operating voltage of the motor of the motorized brake pressure build-up device, a motor torque of the motor of the motorized brake pressure build-up device, a power consumption of the motor of the motorized brake pressure build-up device (also during a driver-induced braking process) and an adjustment path of the at least one adjustable piston of the motorized brake pressure build-up device can also be ascertained as the at least one brake system response variable p₁₂, I and p₁₆ instead of, or in addition to, the motor current intensity I.

In sub-step S1c, at least one brake pressure p₁₆ in at least one wheel brake cylinder 16 of the brake system and controller state information about any performed brake pressure control, such as an anti-lock braking system control, or about any performed driving dynamics control are also determined. Optionally, at least one temperature on and/or in at least the motorized brake pressure build-up device, a pump rate of the at least one pump 14 used in the brake system, a gearbox efficiency of a gearbox of the brake system connected to the motorized brake pressure build-up device, and/or at least one switching state of at least one valve of the brake system can also be ascertained as the at least one brake system response variable p₁₂, I and p₁₆.

Sub-step S1d is likewise performed at the respective point in time of the associated value group. Sub-step S1d serves to ascertain the at least one vehicle response variable F, α, r and a, which reflects a physical variable of the vehicle braked by means of the brake system. Only by way of example, in the embodiment of FIGS. 1A to 1G, a braking force F produced on the vehicle by means of the brake system, a steering angle x of the vehicle, a yaw rate r of the vehicle, and a vehicle deceleration a produced on the vehicle by means of the brake system are ascertained as the at least one vehicle response variable F, a, r and a. Alternatively, or additionally, a braking torque produced on the vehicle by means of the brake system, a longitudinal velocity of the vehicle, a lateral velocity of the vehicle, a lateral acceleration of the vehicle, and/or an on-board power supply voltage of an on-board power system of the vehicle can also be determined as the at least one vehicle response variable F, a, r and a.

Sub-steps S1a to S1d described here thus enable “cascade-like” monitoring/tracking of how the actuation of the brake pedal by the driver and/or the braking request specification of the automatic braking or driving control system affects the vehicle braked by means of the brake system, as a response of at least the one brake system component. Method step S1 focuses on bringing together the individual monitoring results from monitoring, electrical considerations and thermal considerations. Method step S1 thus makes clear a relationship between the driver braking request and/or the braking request specification of the automatic braking or driving control system, the component behavior of at least the one brake system component of the brake system and the driving state of the vehicle. As understood on the basis of the description below, a consolidated brake model or brake map can be created in this way, which can be used for the prediction for at least the one brake system component of the brake system.

In the embodiment described here, method step S1 furthermore comprises a sub-step S1e as an optional development. Sub-step S1e is performed at the same point in time as when the at least one braking request specification variable x, vₓ and I₀, the at least one brake system response variable p₁₂, I and p₁₆ and the at least one vehicle response variable F, α, r and a of the respective value group are ascertained. In sub-step S1e, at least one environmental parameter μ with respect to a current environment of the vehicle is ascertained at the respective point in time of the associated value group and is added to the respective value group. By way of example, in the embodiment described here, a roadway friction μ is ascertained in sub-step S1e as the at least one environmental parameter μ. Alternatively, or additionally, a roadway inclination angle, a windshield wiper status and/or an outside temperature can also be (co-) determined as the at least one environmental parameter μ.

It is expressly pointed out here that the values of a common value group are respectively ascertained at the same point in time. Sub-steps S1a to S1d or S1a to S1e are thus performed simultaneously for each value group and are repeated correspondingly often for the multitude of value groups. In an optional method step S2 after method step S1 (but before performing a method step S3), value groups that are ascertained at an outside temperature outside of a specified normal temperature range, at an adjustment velocity vₓ of the brake pedal, adjusted by the driver, outside of a specified normal velocity range, at an on-board power supply voltage outside of a specified normal voltage range, during a failure of a data provisioning device and/or during a fading, can be filtered out.

In this case, method step S3 described below is performed without the co-use of the value groups filtered out in method step S2. Alternatively, the “filtered-out” value groups can also be evaluated separately from the “non-filtered-out” value groups in the manner described below.

In method step S3, the ascertained (and non-filtered-out) value groups are entered into coordinate systems, wherein each of the coordinate systems has at least two axes, which respectively indicate the braking request specification variable or at least one of the braking request specification variables x, vₓ and I₀, the brake system response variable or at least one of the brake system response variables p₁₂, I and p₁₆, and/or the vehicle response variable or at least one of the vehicle response variables F, α, r and a. If the at least one environmental parameter μ is also co-determined as method step S1e, the value groups in method step S3 can also be entered into at least one further coordinate system in which the environmental parameter μ or at least one of the environmental parameters is indicated by means of an axis of the respective coordinate system or by means of sectors in a plane spanned by two axes of the respective coordinate system. The at least one other axis of the at least one further coordinate system indicates the braking request specification variable or at least one of the braking request specification variables x, vₓ and I₀, the brake system response variable or at least one of the brake system response variables p₁₂, I and p₁₆, and/or the vehicle response variable or at least one of the vehicle response variables F, α, r and a.

FIGS. 1B to 1G show examples of the coordinate systems created in method step S3:

In the coordinate system of FIG. 1B, a first axis reflects the adjustment velocity vₓ of the brake pedal, a second axis reflects the master brake cylinder pressure p₁₂, and a third axis reflects a frequency N of the value groups ascertained for the respective values of the adjustment velocity vₓ and of the master brake cylinder pressure p₁₂. By means of the value groups entered into the coordinate system of FIG. 1B, brake maneuvers performed by the vehicle during the driver-induced and/or autonomous braking processes are obtained, e.g., a “quick braking” marked by arrow 18, a “slow reversing of the brake pedal actuation” marked by arrow 20, a “slow braking and slow reversing of the brake pedal actuation” marked by arrow 22, and an ABS control method, marked by marking 24, at high friction μ.

In the coordinate system of FIG. 1C as well, a first axis indicates the adjustment velocity vₓ of the brake pedal and a second axis indicates the master brake cylinder pressure p₁₂. However, the third axis of the coordinate system of FIG. 1C reflects the motor current intensity I of the motor of the electromechanical brake power booster 10 used as the motorized brake pressure build-up device. Arrows 26 of the coordinate system of FIG. 1C also reflect braking maneuvers, which are, however, not explained in more detail here.

The coordinate system of FIG. 1D reflects braking maneuvers, taking into account the controls performed meanwhile, wherein a first axis reflects the rod path x of the brake pedal, a second axis reflects the master brake cylinder pressure p₁₂, and a third axis reflects the frequency N. As can be seen in the coordinate system of FIG. 1D, an area of the coordinate system spanned by the first axis and the second axis is divided into several sectors C1 to C3, which respectively indicate an ABS control method at low friction μ (sector C1), an ABS control method at medium friction μ (sector C2), and an ABS control method at high friction μ (sector C3).

In the coordinate system of FIG. 1E, a first axis reflects the vehicle deceleration a, a second axis reflects the steering angle α, and a third axis reflects the yaw rate r.

In the coordinate system of FIG. 1F as well, a first axis reflects the adjustment velocity vₓ of the brake pedal, a second axis reflects the master brake cylinder pressure p₁₂, and a third axis reflects a frequency N of the value groups ascertained for the respective values of the adjustment velocity vₓ and of the master brake cylinder pressure p₁₂. Marked braking maneuvers in the coordinate system of FIG. 1F are a “quick braking” marked by arrow 18, a “braking at medium velocity” marked by arrow 28, a “slow reversing of the brake pedal actuation” marked by arrow 20, a “slow braking and slow reversing of the brake pedal actuation” marked by arrow 22, and an ABS control method, marked by marking 24, at high friction μ.

Furthermore, in the coordinate system of FIG. 1G, the rod path x of the brake pedal is indicated by means of a first axis, the master brake cylinder pressure p₁₂ is indicated by means of a second axis, and the frequency N is indicated by means of a third axis. An area of the coordinate system spanned by the first axis and the second axis is divided into the sectors C1 to C3 already described above.

Method step S3 additionally enables detection of the current and cumulative loads and load profiles for each driving situation, even if this is not depicted in the coordinate systems explained above.

In a further method step S4 of the prediction method described herein, it is estimated on the basis of the coordinate systems whether an occurrence of at least one functional impairment of at least the one brake system component of the brake system is probable at least during a specified prediction time interval. Method step S4 thus makes use of the fact that it can be recognized early on the basis of the coordinate systems whether a behavior of at least the one brake system component in the interconnected system (and possibly in conjunction with environmental factors) is due to damage of at least the one brake system component or to wear of at least the one brake system component. In contrast to the common detecting and rather reactive options of the related art for recognizing damages or signs of wear on a brake system, performing the prediction method described herein enables an early diagnosis or a preventive recognition of damage or wear of at least the one brake system component.

The prediction method described herein is thus a very sensible possibility of early recognition of faults or functional impairments on the respective brake system. Advantageously, it can be reliably predicted on the basis of the respectively created coordinate systems whether a still functional brake system component of the brake system will at best have a limited functionality in the near future. In particular, “starting faults” on the brake system can be recognized/predicted on the basis of the respectively created coordinate systems. The method steps S1 and S4 to be performed for this purpose can be performed by means of comparatively cost-effective and relatively small-volume electronics.

By means of the prediction method, an overall functionality of the electromechanical brake power booster or of the integrated plunger device can, in particular, also be examined with regard to a prediction of their future usability/functionality. In particular, future failures of the electromechanical brake power booster or of the integrated plunger device can also be predicted by means of this method, which failures cannot be predicted by means of conventional monitoring methods and sensors according to the related art, e.g., by means of a motor position sensor or a differential sensor. The prediction method described herein thus enables an advantageous early diagnosis, in particular for the electromechanical brake power booster or the integrated plunger device of the brake system of the vehicle. It is expressly pointed out, however, that other brake system components can also be examined with respect to an impending functional impairment/a future failure by means of the prediction method.

On the basis of the detection of the current and cumulative loads and load profiles performed in method step S3, deviations can be recognized, which are then confirmed or invalidated in method step S4 via elimination methods and plausibility check methods. The deviations can be due to wear or damage. Deviations of known patterns can in particular be an indication of slow wear. By means of method step S4, stress profiles can also be predicted.

In particular, if it is projected/predicted in method step S4 that an occurrence of at least one functional impairment of at least the one brake system component of the brake system is probable during the prediction time interval, a corresponding warning can be transmitted as an optional method step S5 to the driver of the vehicle by means of a light indicator, by means of an audio output, and/or by means of a display screen. At least one light element of the vehicle, one audio output device of the vehicle, one display screen device of the vehicle, and/or one mobile device of the driver, in particular their mobile phone, can be used to transmit the warning. The driver can thus be prompted in a variety of ways to visit a repair shop. Alternatively, or additionally, in method step S5, service information corresponding to the prediction may also be transmitted to the repair shop.

However, if it is projected/predicted in method step S4 that no occurrence of at least one functional impairment of at least the one brake system component of the brake system is to be expected during the prediction time interval, an approval criterion for autonomously driving the vehicle can also be output as optional method step S6. Accordingly, if it is projected/predicted in method step S4 that an occurrence of at least one functional impairment of at least the one brake system component of the brake system is probable during the prediction time interval, the approval criterion for autonomously driving the vehicle can be deactivated. Preferably, in this case, the automatic system used for autonomously driving the vehicle is designed in such a way that the automatic system is only switched to an operating mode suitable for autonomously driving the vehicle, if the approval criterion is present. In this way, it is ensured that the vehicle is only set to drive autonomously if a functional impairment of its brake system can be ruled out with a high probability for at least the probable duration of the autonomous driving.

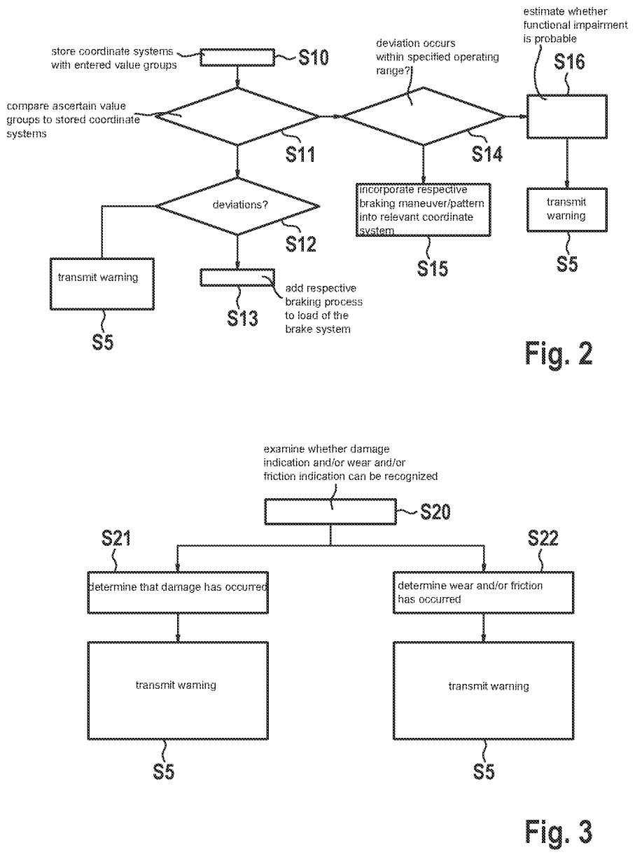

FIG. 2 shows a flowchart for explaining a second embodiment of the prediction method.

The prediction method of FIG. 2 is a development of the embodiment described above. Its feasibility is not restricted to a specific brake system type or to a particular vehicle type.

As a development of the above-described embodiment, after method step S4, a method step S10 is performed, in which the coordinate systems with the entered value groups are stored in a memory device. Thereafter, value groups ascertained during further driver-induced and/or autonomous braking processes of the vehicle are compared to the coordinate systems stored in the memory device. This is indicated with method step S11. The comparison is used to ascertain whether a braking maneuver of the braking process currently being performed by the vehicle deviates from comparative braking maneuvers of the braking processes performed during the ascertainment of the value groups of the coordinate systems. If the braking maneuver of the braking process currently being performed by the vehicle corresponds to at least one of the comparative braking maneuvers, it is examined in a method step S12 whether deviations occur in at least one of the coordinate systems during the driving predicted for the respective braking maneuver. If this is not the case, the respective braking process is only added to the load of the brake system as method step S13. Otherwise, if deviations in known braking maneuvers occur repeatedly, method step S5 already described above is performed.

If, however, it is detected in method step S11 that the braking maneuver of the braking process currently being performed by the vehicle deviates from the comparative braking maneuvers, it is examined as method step S14 whether the respective deviation occurs within a specified operating range. If this is the case, as method step S15, the respective braking maneuver/pattern is incorporated into the relevant coordinate systems in response to a repeated occurrence of this braking maneuver in the respectively specified operating range. Otherwise, as method step S16, a frequency of the braking maneuvers of the braking processes that are currently being performed by the vehicle and deviate from the comparative braking maneuvers is ascertained. On the basis of the ascertained frequency, it is then estimated in method step S16 whether an occurrence of at least one functional impairment of at least the one brake system component of the brake system is probable at least during the specified prediction time interval. Thereafter, method step S5 can again be performed.

FIG. 3 shows a flowchart for explaining a third embodiment of the prediction method.

The prediction method of FIG. 3 is also a development of the embodiment of FIGS. 1A-1G. Its feasibility is not restricted to a specific brake system type or to a particular vehicle type.

In the prediction method of FIG. 3, after method step S4, a method step S20 is performed, in which it is examined whether at least one damage indicator and/or at least one wear and/or friction indicator can be recognized on the basis of at least one of the coordinate systems. A respective damage indicator is an indication that a fault or failure of at least the one brake system component is due to damage of at least the one brake system component, e.g., due to an impact load of at least the one brake system component. A respective damage indicator can frequently be recognized on the basis of pedal dynamics of the brake pedal, a driving profile of the vehicle, and/or at least one gradient of at least one mechanical or electrical variable. Correspondingly, a respective wear and/or friction indicator is an indication that a fault or failure of at least the one brake system component is due to wear of at least the one brake system component and/or due to friction occurring on at least the one brake system component. A respective wear and/or friction indicator can often be detected on the basis of a motor torque of the motor of the motorized brake pressure build-up device, a rotational speed of the motor of the motorized brake pressure build-up device, an electrical or mechanical power of the motorized brake pressure build-up device, and/or at least one measured temperature.

If the presence of at least one damage indicator is recognized on the basis of the coordinate systems in method step S20, it is determined in a method step S21 that damage to at least the one brake system component has occurred. If necessary, method step S5 already described above can then be performed. If, however, the presence of at least one wear and/or friction indicator is detected in method step S20, it is determined as method step S22 that wear of at least the one brake system component and/or friction occurring on at least the one brake system component can be recognized. In this case as well, method step S5 already described above can then be performed.

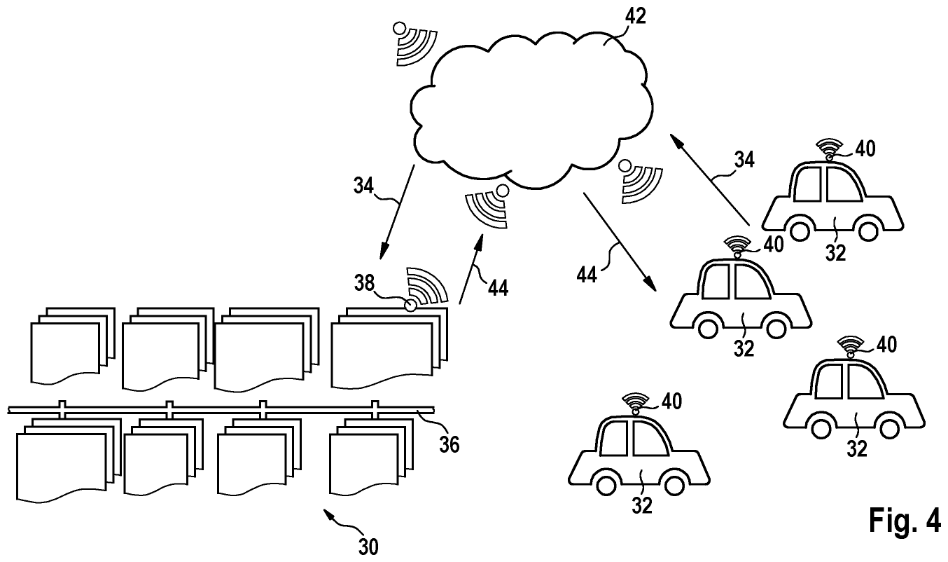

FIG. 4 shows a schematic representation of an embodiment of the prediction device.

The prediction device 30 described below can be used for prediction, in particular for early diagnosis, for at least one brake system component of a brake system of a vehicle 32. Usability of the prediction device 30 described below is restricted neither to a particular brake system type of the respective brake system nor to a specific vehicle type/motor vehicle type of the vehicle/motor vehicle 32 equipped with the respective brake system.

By means of the prediction device 30, a prediction, in particular an early diagnosis, can be created for at least one brake system component of the brake system of the vehicle 32. For this purpose, value groups 34 are provided to an electronic device 36 of the prediction device 30. The value groups 34 respectively have values ascertained during several driver-induced and/or autonomous braking processes of the vehicle 32. In addition, the value groups 34 respectively comprise at least one braking request specification variable ascertained at a point in time, at least one brake system response variable ascertained at the same point in time, and at least one vehicle response variable ascertained at the same point in time. As already explained above, the at least one braking request specification variable respectively reflects an actuation of a brake pedal by a driver of the vehicle 32 and/or a braking request specification of an automatic braking or driving control system of the vehicle 32. Correspondingly, the at least one brake system response variable respectively indicates a response of at least the one brake system component of the brake system to the at least one braking request specification variable or to a state on and/or in at least the one brake system component. In addition, the at least one vehicle response variable reflects a physical variable of the vehicle 32 braked by means of the brake system. Examples of the at least one braking request specification variable, the at least one brake system response variable and the at least one vehicle response variable are already listed above.

The electronic device 36 is designed and/or programmed to enter the value groups 34 into coordinate systems, wherein each of the coordinate systems has at least two axes, which respectively indicate the braking request specification variable or at least one of the braking request specification variables, the brake system response variable or at least one of the brake system response variables, and/or the vehicle response variable or at least one of the vehicle response variables. As likewise already stated above, if the value groups 34 also have at least one environmental parameter ascertained at the respective point in time of the associated value group 34, the value groups may also be entered into corresponding further coordinate systems.

Furthermore, the electronic device 36 is also designed and/or programmed to estimate on the basis of the coordinate systems whether an occurrence of at least one functional impairment of at least the one brake system component of the brake system is probable at least during a specified prediction time interval. The prediction device 30 described herein thus produces the advantages of the prediction method already explained above. The prediction device 30/its electronic device 36 can in particular be designed/programmed to perform all method steps of the prediction method already explained above.

The prediction device 30 can be understood to mean a prediction device 30 that can be mounted/installed on the vehicle 32. However, as depicted in FIG. 4, the prediction device 30 can also comprise a communication device 38 designed to receive the value groups 34 transmitted by a data transmitting device 40 of the vehicle 32, in particular via the Internet 42. Prediction information 44 determined by the prediction device 30/the electronic device 36 thereof can then be transmitted back to the vehicle 32. On the vehicle 32, the prediction information 44 can then trigger the method steps S5 and S6 already explained above.

The prediction device 30 can thus still perform the advantageous prediction/early diagnosis even at a relatively large distance between it and the vehicle 32. The cooperation of the prediction device 30 with the vehicle 32 thus does not increase the weight of the vehicle 32, and available installation space on the vehicle 32 is not required for the prediction device 30. This also enables a comparatively large-volume and/or relatively heavy design of the prediction device 30, without compromising the usability of the prediction device 30. In addition, the cooperation of the prediction device 30 with the vehicle 32 is in this case also possible without increasing the production costs of the vehicle 32. As depicted in FIG. 4, for performing the prediction/early diagnosis, the prediction device 30 equipped with the communication device 38 can also cooperate with several vehicles 32. Since vehicles 32 are generally equipped with their own data transmitting device 40, the prediction device 30 can thus be used widely. Optionally, an early diagnosis may in this way also be performed “at 2 levels” by first creating the prediction at the vehicle level and by finally correlating across a vehicle fleet of several/many vehicles 32 “at the higher level” of the cloud.

1-11. (canceled)

12. A prediction device for at least one brake system component of a brake system of a vehicle, the prediction device comprising:
an electronic device configured to:
enter value groups into coordinate systems, the value groups being provided to the electronic device and respectively have values ascertained during several driver-induced and/or autonomous braking processes of the vehicle, and respectively include at least one braking request specification variable ascertained at a point in time, at least one brake system response variable ascertained at the same point in time, and at least one vehicle response variable ascertained at the same point in time, wherein: (i) the at least one braking request specification variable respectively reflects an actuation of a brake pedal by a driver of the vehicle and/or a braking request specification of an automatic braking or driving control system of the vehicle, (ii) the at least one brake system response variable respectively reflects a response of at least the one brake system component of the brake system to the at least one braking request specification variable or to a state on and/or in at least the one brake system component, and (iii) the at least one vehicle response variable reflects a physical variable of the vehicle braked using the brake system, wherein each of the coordinate systems has at least two axes, which respectively indicate: (i) the braking request specification variable or at least one of the braking request specification variables, and/or (ii) the brake system response variable or at least one of the brake system response variables, and/or the vehicle response variable or at least one of the vehicle response variables; and
estimate, based on the coordinate systems, whether an occurrence of at least one functional impairment of at least the one brake system component of the brake system is probable at least during a specified prediction time interval.

13. The prediction device according to claim 12, wherein the electronic device is configured to store the coordinate systems with the entered value groups in a memory device of the prediction device, and wherein the electronic device is additionally configured to compare value groups ascertained during further driver-induced and/or autonomous braking processes of the vehicle to the coordinate systems stored in the memory device, to ascertain. based on the comparison, whether a braking maneuver of the braking process currently being performed by the vehicle deviates from comparative braking maneuvers of the braking processes performed during the ascertainment of the value groups of the coordinate systems, and to estimate, additionally taking into account an ascertained frequency of the braking maneuvers of the braking processes that are currently being performed by the vehicle and deviate from the comparative braking maneuvers, whether an occurrence of at least one functional impairment of at least the one brake system component of the brake system is probable at least during the specified prediction time interval.

14. The prediction device according to claim 12, wherein the prediction device is configured to be mounted on the vehicle.

15. The prediction device according to claim 12, further comprising:
a communication device configured to receive the value groups transmitted by a data transmitting device of the vehicle.

16. A prediction method for at least one brake system component of a brake system of a vehicle, the method comprising the following steps:
ascertaining value groups which respectively have values ascertained during several driver-induced and/or autonomous braking processes of the vehicle, and respectively include at least one braking request specification variable ascertained at a point in time, at least one brake system response variable ascertained at the same point in time, and at least one vehicle response variable ascertained at the same point in time, wherein: (i) the at least one braking request specification variable respectively reflects an actuation of a brake pedal by a driver of the vehicle and/or a braking request specification of an automatic braking or driving control system of the vehicle, (ii) the at least one brake system response variable respectively reflects a response of at least the one brake system component of the brake system to the at least one braking request specification variable or to a state on and/or in at least the one brake system component, and (iii) the at least one vehicle response variable reflects a physical variable of the vehicle braked using the brake system;
entering the ascertained value groups into coordinate systems, wherein each of the coordinate systems has at least two axes, which respectively indicate: (i) the braking request specification variable or at least one of the braking request specification variables, and/or the brake system response variable or at least one of the brake system response variables, and/or the vehicle response variable or at least one of the vehicle response variables; and
estimating, based on the coordinate systems, whether an occurrence of at least one functional impairment of at least the one brake system component of the brake system is probable at least during a specified prediction time interval.

17. The prediction method according to claim 16, wherein at least one of the following is ascertained as the at least one braking request specification variable: (i) a rod path of an input rod connected to a brake pedal, and/or (ii) an adjustment velocity of the input rod, and/or (iii) a target motor current intensity of a motor of a motorized brake pressure build-up device of the brake system requested by an automatic braking or driving control system, and/or (iv) a target operating voltage of the motor of the motorized brake pressure build-up device requested by the automatic braking or driving control system, and/or (v) a target motor torque of the motor of the motorized brake pressure build-up device requested by the automatic braking or driving control system, and/or (vi) a target power consumption of the motor of the motorized brake pressure build-up device requested by the automatic braking or driving control system, (vii) a target adjustment path of at least one adjustable piston of the motorized brake pressure build-up device requested by the automatic braking or driving control system, and/or (viii) a target pump rate of at least one pump used in the brake system, the pump rate being requested by the automatic braking or driving control system.

18. The prediction method according to claim 16, wherein, at least one of the following is ascertained as the at least one brake system response variable: (i) a master brake cylinder pressure in a master brake cylinder of the brake system, and/or (ii) at least one brake pressure in at least one wheel brake cylinder of the brake system, and/or (iii) a motor current intensity of a motor of a motorized brake pressure build-up device of the brake system, and/or (iv) an operating voltage of the motor of the motorized brake pressure build-up device, and/or (v) a motor torque of the motor of the motorized brake pressure build-up device, and/or (vi) a power consumption of the motor of the motorized brake pressure build-up device, and/or (vii) an adjustment path of at least one adjustable piston of the motorized brake pressure build-up device, and/or (viii) controller state information about any performed brake pressure control or any performed driving dynamics control, and/or (ix) at least one temperature on and/or in at least the motorized brake pressure build-up device, and/or (x) a pump rate of at least one pump used in the brake system, and/or (xi) a gearbox efficiency of a gearbox of the brake system connected to the motorized brake pressure build-up device, and/or (xii) at least one switching state of at least one valve of the brake system.

19. The prediction method according to claim 16, wherein at least one of the following is ascertained as the at least one vehicle response variable: (i) a brake power produced on the vehicle using the brake system, and/or (ii) a braking torque produced on the vehicle using the brake system, and/or (iii) a steering angle of the vehicle, and/or (iv) a yaw rate of the vehicle, and/or (v) a vehicle deceleration produced on the vehicle using the brake system, and/or (vi) a longitudinal velocity of the vehicle, and/or (vii) a lateral velocity of the vehicle, and/or (viii) a lateral acceleration of the vehicle, and/or (ix) an on-board power supply voltage of an on-board power supply of the vehicle.

20. The prediction method according to claim 16, wherein, in addition to the at least one braking request specification variable ascertained at the respective point in time of the associated value group, the at least one brake system response variable ascertained at the same point in time, and the at least one vehicle response variable of the respective value group ascertained at the same point in time, at least one environmental parameter with respect to a current environment of the vehicle is ascertained at the same point in time and added to the respective value group, wherein the value groups are entered into at least one further coordinate system in which the environmental parameter or at least one of the environmental parameters is indicated using an axis of the respective further coordinate system or using sectors in a plane spanned by two axes of the respective further coordinate system, and wherein, additionally taking into account the at least one further coordinate system, it is estimated whether an occurrence of at least one functional impairment of at least the one brake system component of the brake system is probable at least during the specified prediction time interval.

21. The prediction method according to claim 20, wherein at least one of the following is ascertained as the at least one environmental parameter: (i) a roadway friction, and/or (ii) a roadway inclination angle, and/or a windshield wiper status, and/or an outside temperature.

22. The prediction method according to claim 16, wherein the coordinate systems with the entered value groups are stored in a memory device, wherein value groups ascertained during further driver-induced and/or autonomous braking processes of the vehicle are compared to the coordinate systems stored in the memory device, to ascertain, based on the comparison, whether a braking maneuver of the braking process currently being performed by the vehicle deviates from comparative braking maneuvers of the braking processes performed during the ascertainment of the value groups of the coordinate systems, and wherein, additionally taking into account an ascertained frequency of the braking maneuvers of the braking processes that are currently being performed by the vehicle and deviate from the comparative braking maneuvers, it is estimated whether an occurrence of at least one functional impairment of at least the one brake system component of the brake system is probable at least during the specified prediction time interval.
